(19) United States
(12) Patent Application Publication
(10) Pub. No.: US 2005/0022045 A1
(43) Pub. Date: Jan. 27, 2005

(54) Method and system for node failure detection

(76) Inventors: Jean-Marc Fenart, MOntigny Le Bretonneux (FR); Stephane Carrez, Les-Moulineaux (FR)

Correspondence Address: OSHA & MAY L.L.P., 1221 MCKINNEY STREET, HOUSTON, TX, 77010, US

(21) Appl. No.: 10/485,846

(22) PCT Filed: Aug. 2, 2001
(86) PCT No.: PCT/IB01/01381

(51) Int. Cl. G06F 11/00

(52) U.S. Cl. 714/4

(57) ABSTRACT

A distributed computer system, including a group of nodes. Each of the nodes have a network operating system, enabling one-to-one messages and one-to-several messages between said nodes, a first function capable of marking a pending message as in error, a node failure storage function, and a second function. The second function being responsive to the node failure storage function indicating a given node as failing, for calling said first function to force marking selected messages to that given node into error, the selected messages include pending messages which satisfy a given condition.

The invention relates to network equipments, an example of which are the equipments used in a telecommunication network system.

Telecommunication users may be connected between them or to other telecommunication services through a succession of equipments, which may comprise terminal devices, base stations, base station controllers, and an operation management center, for example. Base station controllers usually comprise nodes exchanging data on a network.

Within such a telecommunication network system, it may happen that data sent from a given node do not reach their intended destination, e.g. due to a failure in the destination node, or within intermediate nodes. In that case, the sending node should be informed of the node failure condition.

A requirement in such a telecommunication network system is to provide a high availability, i.e. comprising a good serviceability and a good failure maintenance. A pre-requisite is then to have a fast mechanism for failure discovery, so that continuation of service may be ensured in the maximum number of situations. Preferably, the failure discovery mechanism should also be compatible with the need to stop certain equipments for maintenance and/or repair. Thus, the mechanism should detect a node failure condition and inform the interested nodes, both in a fast way.

The known Transmission Control Protocol (TCP) has a built-in capability to detect network failure. However, this built-in capability involves potentially long and unpredictable delays. On another hand, the known User Datagram Protocol (UDP) has no such capability.

A general aim of the present invention is to provide advances with respect to such mechanisms.

The invention comprises a distributed computer system, comprising a group of nodes, each having:
a network operating system, enabling one-to-one messages and one-to-several messages between said nodes,
a first function capable of marking a pending message as in error,
a node failure storage function, and
a second function, responsive to the node failure storage function indicating a given node as failing, for calling said first function to force marking selected messages to that given node into error, the selected messages comprising pending messages which satisfy a given condition.

The invention also comprises a method of managing a distributed computer system, comprising a group of nodes, said method comprising the steps of:
a. detecting at least one failing node in the group of nodes,
b. issuing identification of that given failing node to all nodes in the group of nodes,
c. responsive to step b,
c1. storing an identification of that given failing node in at least one of the nodes,
c2. calling a function in at least one of the nodes to force marking selected messages between that given failing node and said node into error, the selected messages comprising pending messages which satisfy a given condition.

Other alternative features and advantages of the invention will appear in the detailed description below and in the appended drawings, in which:

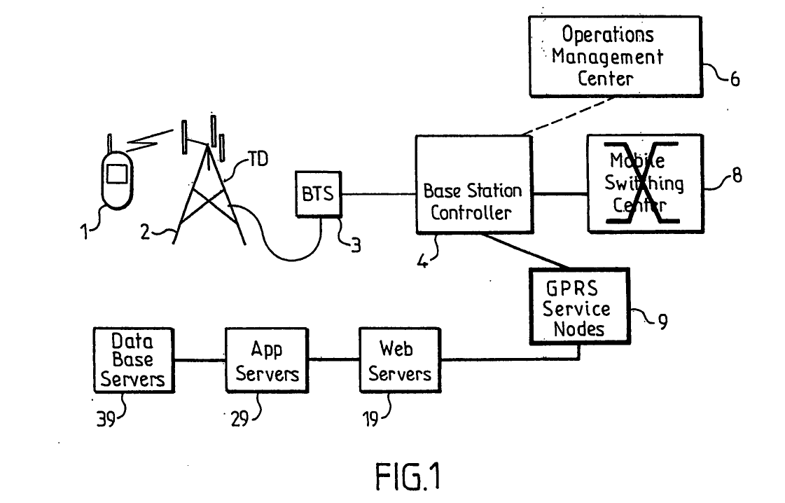

FIG. 1 is a general diagram of a telecommunication network system in which the invention is applicable;

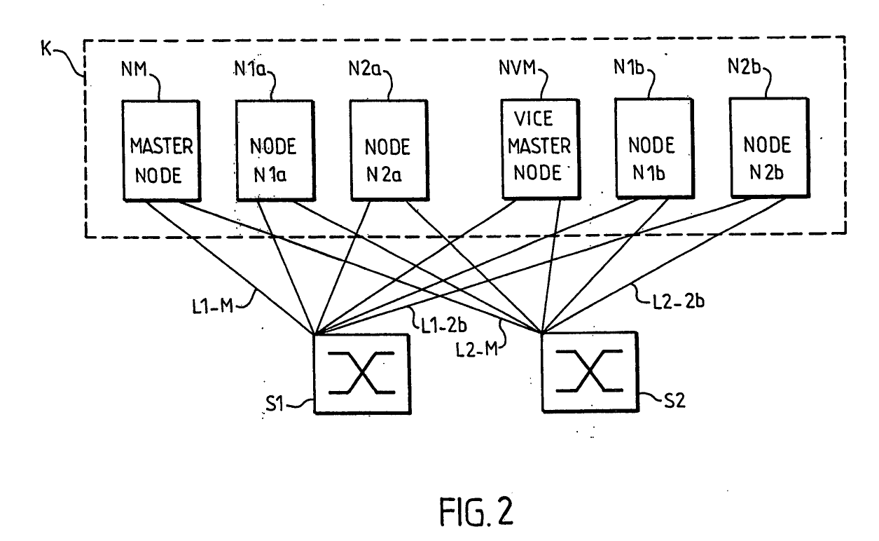

FIG. 2 is a general diagram of a monitoring platform;

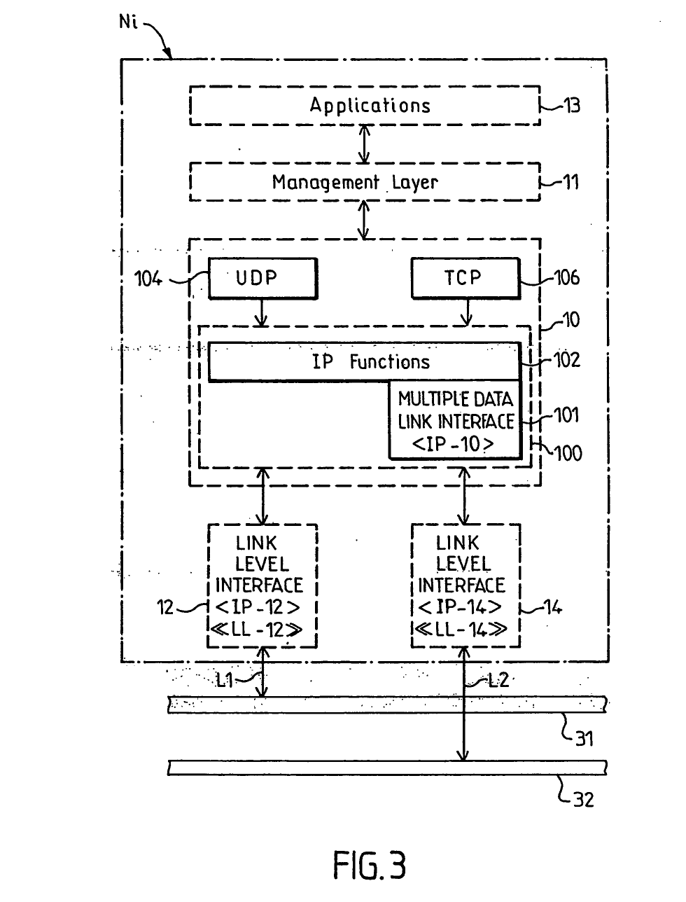

FIG. 3 is a partial diagram of a monitoring platform;

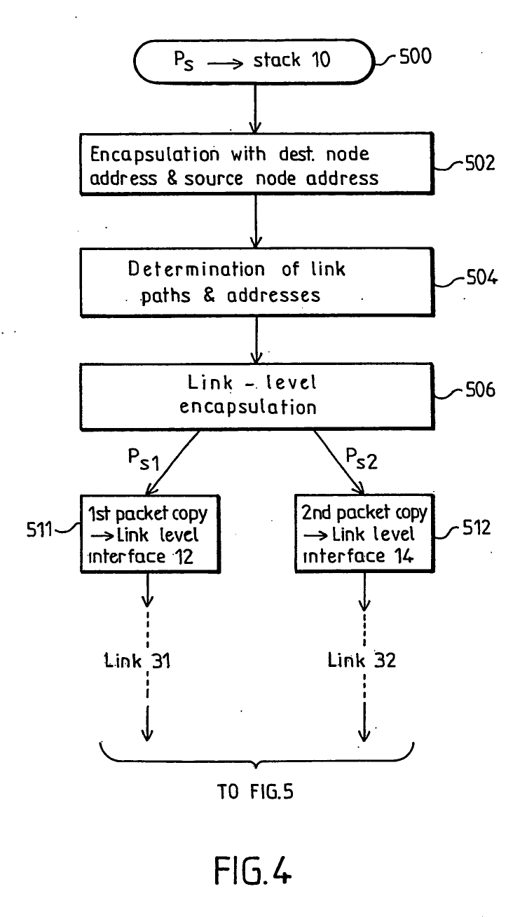

FIG. 4 is a flow chart of a packet sending mechanism,

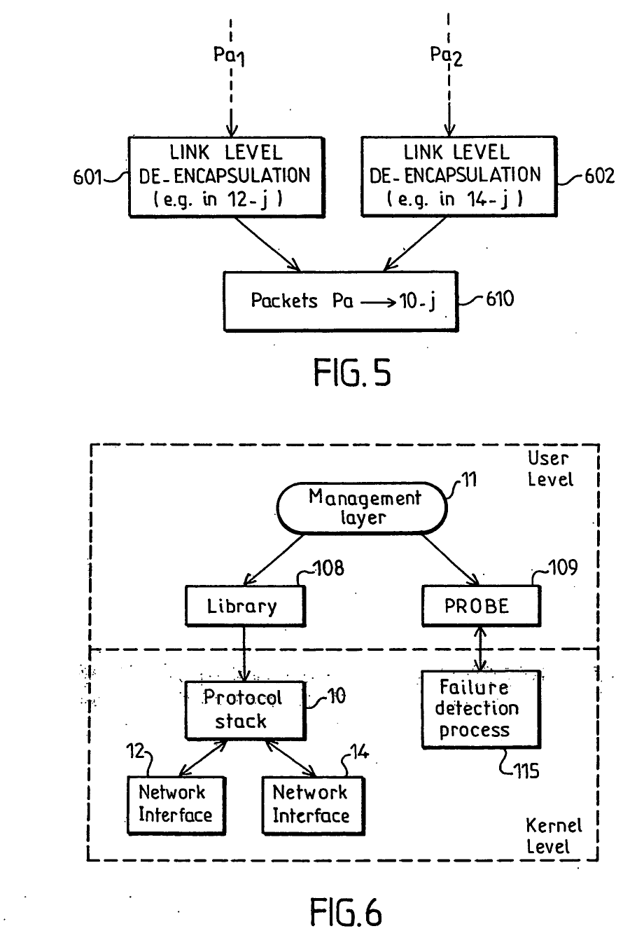

FIG. 5 is a flow chart of packet receiving mechanism,

FIG. 6 illustrates an example of implementation according to the invention;

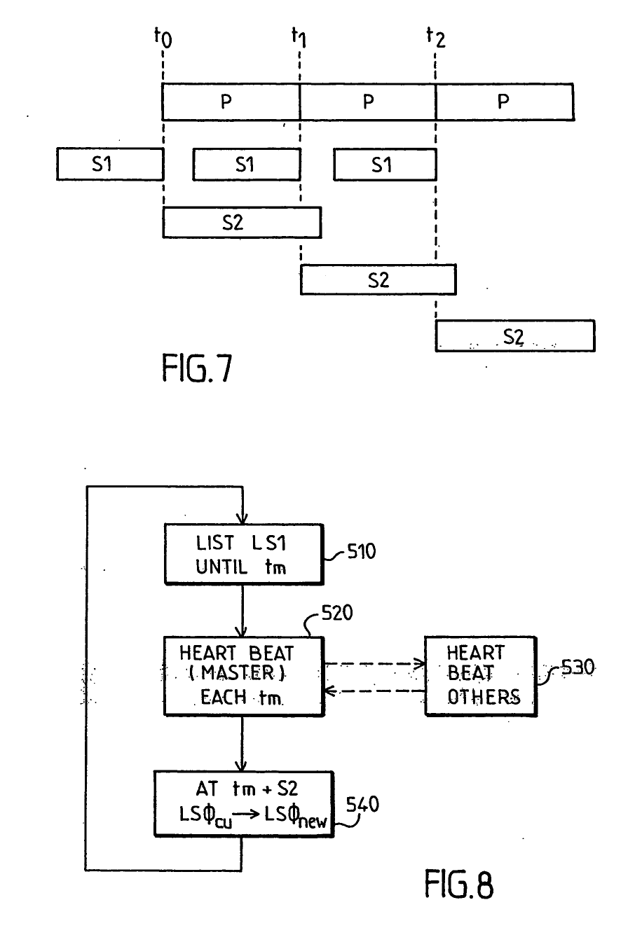

FIG. 7 is an example of delay times for a protocol according to the invention;

FIG. 8 is a first part of a flow-chart of a protocol in accordance with the invention;

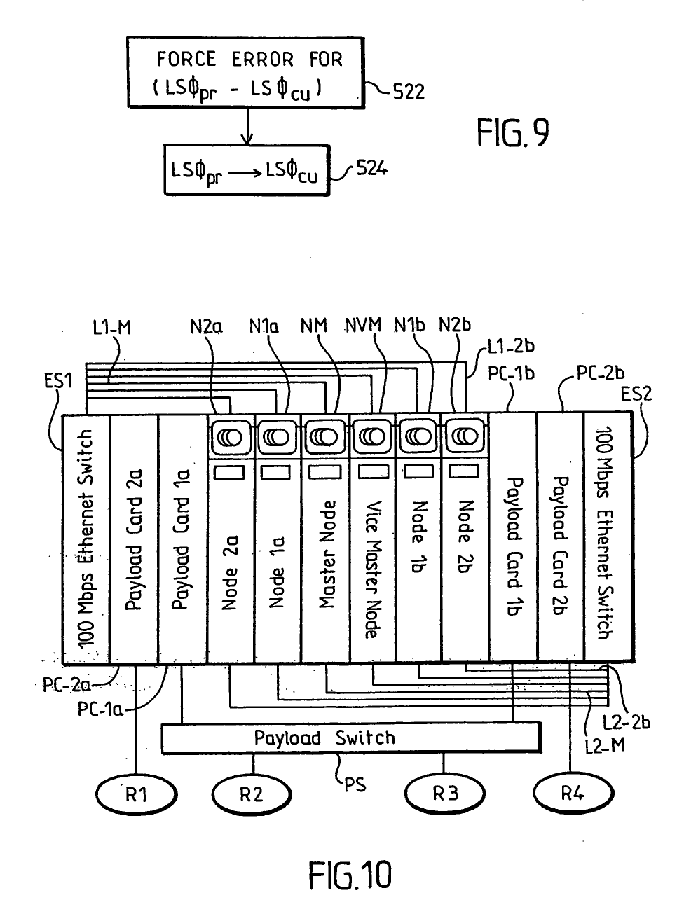

FIG. 9 is a second part of a flow-chart of a protocol in accordance with the invention; and

FIG. 10 is an application example of the invention in a telecommunication environment.

Additionnally, the detailed description is supplemented with the following exhibits:
Exhibit I is a more detailed description of a routing table exemplary,

Exhibit II contains code extracts illustrating an examplary embodiment of the invention.

In the foregoing description, references to the Exhibits may be made directly by the Exhibit or Exhibit section identifier. One or more Exhibits are placed apart for the purpose of clarifying the detailed description, and for enabling easier reference. They nevertheless form an integral part of the description of the present invention. This applies to the drawings as well. The appended drawings include graphical information, which may be useful to define the scope of this invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records of each relevant country, but otherwise reserves all copyright and/or author's rights whatsoever.

This invention also encompass software code, especially when made available on any appropriate computer-readable medium. The expression “computer-readable medium” includes a storage medium such as magnetic or optic, as well as a transmission medium such as a digital or analog signal.

FIG. 1 illustrates an exemplary simplified telecommunication network system. Terminal devices (TD) like 1 are in charge of transmitting data, e.g. connection request data, to base transmission stations (BTS) like 3. A such base transmission station 3 gives access to a communication network, under control of a base station controller (BSC) 4. The base station controller 4 comprises communication nodes, supporting communication services (“applications”). Base station controller 4 also uses a mobile switching center 8 (MSC), adapted to orientate data to a desired communication service (or node), and further service nodes 9 (General Packet Radio Service, GPRS), giving access to network services, e.g. Web servers 19, application servers 29, data base server 39. Base station controller 4 is managed by an operation management center 6 (OMC).

The nodes in base station controller 4 may be organized in one or more groups of nodes, or clusters.

FIG. 2 shows an example of a group of nodes arranged as a cluster K. For redundancy purposes, the cluster K may be comprised of two or more sub-clusters, for example first and second sub-clusters, which are preferably identical, or, at least, equivalent. At a given time, one of the sub-clusters (“main”) has leadership, while the other one (“vice” or redundant) is following.

The main sub-cluster has a master node NM, and other nodes 1a and 2a. The “vice” sub-cluster has a vice-master node NVM, and other nodes N1b and N2b. Further nodes may be added in the main sub-cluster, together with their corresponding redundant nodes in the “vice” sub-cluster. Again, the qualification as master or as vice-master should be viewed as dynamic: one of the nodes acts as the master (resp. Vice-master) at a given time. However, for being eligible as a master or vice-master, a node needs to have the required “master” functionalities.

References to the drawings in the following description will use two different indexes or suffixes i and j, each of which may take anyone of the values: {M, 1a, 2a, . . . , VM, 1b, 2b, . . . }. The index or suffix i′ may take anyone of the values: {1a, 2a, . . . , VM, 1b, 2b, . . . }.

In FIG. 2, each node Ni of cluster K is connected to a first Ethernet network via links L1-i. An Ethernet switch S1 is capable of interconnecting one node Ni with another node Nj. If desired, the Ethernet link is also redundant: each node Ni of cluster K is connected to a second Ethernet network via links L2-i and an Ethernet switch S2 capable of interconnecting one node Ni with another node Nj (in a redundant manner with respect to operation of Ethernet switch S1). For example, if node N1a sends a packet to node N1b, the packet is therefore duplicated to be sent on both Ethernet networks. The mechanism of redundant network will be explained hereinafter.

In fact, the redundancy may be implemented in various ways. The foregoing description assumes that:
the “vice” sub-cluster may be used in case of a failure of the main sub-cluster;
the second network for a node is used in parallel with the first network.

Also, as an example, it is assumed that packets are generally built throughout the network in accordance with the Internet Protocol (IP), i.e. have IP addresses. These IP addresses are converted into Ethernet addresses on Ethernet network sections.

In a more detailed exemplary embodiment, the identification keys for a packet may be the source, destination, protocol, identification and offset fields, e.g. according to RFC-791. The source and destination fields are the IP address of the sending node and the IP address of the receiving node. It will be seen that a node has several IP addresses, for its various components. Although other choices are possible, it is assumed that the IP address of a node (in the source or destination field) is the address of its multiple interface (to be described).

FIG. 3 shows an exemplary node Ni, in which the invention may be applied. Node Ni comprises, from top to bottom, applications 13, management layer 11, network protocol stack 10, and Link level interfaces 12 and 14, respectively interacting with network links 31 and 32 (also shown in FIG. 2). Node Ni may be part of a local or global network; in the foregoing exemplary description, the network is Internet, by way of example only. It is assumed that each node may be uniquely defined by a portion of its Internet address. Accordingly, as used hereinafter, “Internet address” or “IP address” means an address uniquely designating a node in the network being considered (e.g. a cluster), whichever network protocol is being used. Although Internet is presently convenient, no restriction to Internet is intended.

Thus, in the example, network protocol stack 10 comprises:
an Internet interface 100, having conventional Internet protocol (IP) functions 102, and a multiple data link interface 101,
above Internet interface 100, message protocol processing functions, e.g. an UDP function 104 and/or a TCP function 106.

When the cluster is configured, nodes of the cluster are registered at the multiple data link interface 101 level. This registration is managed by the management layer 11.

Network protocol stack 10 is interconnected with the physical networks through first and second Link level interfaces 12 and 14, respectively. These are in turn connected to first and second network channels 31 and 32, via couplings L1 and L2, respectively, more specifically L1-i and L2-i for the exemplary node Ni. More than two channels may be provided, enabling to work on more than two copies of a packet.

Link level interface 12 has an Internet address <IP_12>and a link layer address <<LL_12>>. Incidentally, the doubled triangular brackets (<< . . . >>) are used only to distinguish link layer addresses from Internet addresses. Similarly, Link level interface 14 has an Internet address <IP_14>and a link layer address <<LL_14>>. In a specific embodiment, where the physical network is Ethernet-based, interfaces 12 and 14 are Ethernet interfaces, and <<LL_12>>and <<LL_14>>are Ethernet addresses.

IP functions 102 comprise encapsulating a message coming from upper layers 104 or 106 into a suitable IP packet format, and, conversely, de-encapsulating a received packet before delivering the message it contains to upper layer 104 or 106.

In redundant operation, the interconnection between IP layer 102 and Link level interfaces 12 and 14 occurs through multiple data link interface 101. The multiple data link interface 101 also has an IP address <IP_10>, which is the node address in a packet sent from source node Ni.

References to Internet and Ethernet are exemplary, and other protocols may be used as well, both in stack 10, including multiple data link interface 101, and/or in Link level interfaces 12 and 14.

Furthermore, where no redundancy is required, IP layer 102 may directly exchange messages with anyone of interfaces 12, 14, thus by-passing multiple data link interface 101.

Now, when circulating on any of links 31 and 32, a packet may have several layers of headers in its frame: for example, a packet may have, encapsulated within each other, a transport protocol header, an IP header, and a link level header.

It is now recalled that a whole network system may have a plurality of clusters, as above described. In each cluster, there may exist a master node.

The operation of sending a packet Ps in redundant mode will now be described with reference to FIG. 4.

At 500, network protocol stack 10 of node Ni receives a packet Ps from application layer 13 through management layer 11. At 502, packet Ps is encapsulated with an IP header, comprising:
the address of a destination node, which is e.g. the IP address IP_10(j) of the destination node Nj in the cluster;
the address of the source node, which is e.g. the IP address IP_10(i) of the current node Ni.

Both addresses IP_10(i) and IP_10(j) may be “intra-cluster” addresses, defined within the local cluster, e.g. restricted to the portion of a full address which is sufficient to uniquely identify each node in the cluster.

In protocol stack 10, multiple data link interface 101 has data enabling to define two or more different link paths for the packet (operation 504). Such data may comprise e.g.:
a routing table, which contains information enabling to reach IP address IP_10(j) using two different routes (or more) to Nj, going respectively through distant interfaces IP_12(j) and IP_14(j) of node Nj. An exemplary structure of the routing table is shown in Exhibit 1, together with a few exemplary addresses;
link level decision mechanisms, which decide the way these routes pass through local interfaces IP_12(i) and IP_14(i), respectively;
additionally, an address resolution protocol (e.g. the ARP of Ethernet) may be used to make the correspondence between the IP address of a Link level interface and its link layer (e.g. Ethernet) address.

In a particular embodiment, Ethernet addresses may not be part of the routing table but may be in another table. The management layer 11 is capable of updating the routing table, by adding or removing IP addresses of new cluster nodes and IP addresses of their Link level interfaces 12 and 14.

At this time, packet Ps is duplicated into two copies Ps1, Ps2 (or more, if more than two links 31, 32 are being used). In fact, the copies Ps1, Ps2 of packet Ps may be elaborated within network protocol stack 10, either from the beginning (IP header encapsulation), or at the time the packet copies will need to have different encapsulation, or in between.

At 506, each copy Ps1, Ps2 of packet Ps now receives a respective link level header or link level encapsulation. Each copy of the packet is sent to a respective one of interfaces 12 and 14 of node Ni, as determined e.g. by the above mentioned address resolution protocol.

In a more detailed exemplary embodiment, multiple data link interface 101 in protocol stack 10 may prepare (at 511) a first packet copy Ps1, having the link layer destination address LL_12(j), and send it through e.g. interface 12, having the link layer source address LL_12(i). Similarly, at 512, another packet copy Ps2 is provided with a link level header containing the link layer destination address LL_14(j), and sent through e.g. interface 14, having the link layer source address LL_14 (i).

On the reception side, several copies of a packet, now denoted generically Pa should be received from the network in node Nj. The first arriving copy is denoted Pa1; the other copy or copies are denoted Pa2, and also termed “redundant” packet(s), to reflect the fact they bring no new information.

As shown in FIG. 5, one copy Pa1 should arrive through e.g. Link level interface 12-j, which, at 601, will de-encapsulate the packet, thereby removing the link level header (and link layer address), and pass it to protocol stack 10(j) at 610. One additional copy Pa2 should also arrive through Link level interface 14-j which will de-encapsulate the packet at 602, thereby removing the link level header (and link layer address), and pass it also to protocol stack 10(j) at 610.

Each node is a computer system with a network oriented operating system. FIG. 6 shows a preferred example of implementation of the functionalities of FIG. 3, within the node architecture.

Protocol stack 10 and a portion of the Link level interfaces 12 and 14 may be implemented at the kernel level within the operating system. In parallel, a failure detection process 115 may also be implemented at kernel level.

In fact, a method called “heart beat protocol” is defined as a failure detection process in addition with a regular detection as a heart beat.

Management layer 11 (Cluster Membership Management) uses a library module 108 and a probe module 109, which may be implemented at the user level in the operating system.

Library module 108 provides a set of functions used by the management layer 11, the protocol stack 10, and corresponding Link level interfaces 12 and 14.

The library module 108 has additional functions, called API extensions, including the following features:
enable the management layer to force pending system calls, e.g. the TCP socket API system calls, of applications having connections to a failed node, to return immediately with an error, e.g. “Node failure indication”;
release all the operating system data related to a failed particular connection, e.g. a TCP connection.

Probe module 109 is adapted to manage regularly the failure detection process 115 and to retrieve information to management layer 11. The management layer 11 is adapted to determine that a given node is in a failure condition and to perform a specific function according to the invention, on the probe module 109.

The use of the functions are hereinafter described.

FIG. 7 shows time intervals used in a presently preferred version of a method of (i) detecting data link failure and/or (ii) detecting node failure as illustrated in FIGS. 8 and 9. The method may be called “heart beat protocol”.

In a cluster, each node contains a node manager, having a so called “Cluster Membership Management” function. The “master” node in the cluster has the additional capabilities of:
activating a probe module to launch a heart beat protocol, and
gathering corresponding information.

In fact, several or all of the nodes may have these capabilities. However, they are activated only in one node at a time, which is the current master node.

This heart beat protocol uses at least some of the following time intervals detailed in FIG. 7:
a first time interval P, which may be 300 milliseconds,
a second time interval S1, smaller than P; S1 may be 300 milliseconds,
a third time interval S2, greater than P; S2 may be 500 milliseconds.

The heart beat protocol will be described as it starts, i.e. seen from the master node. In this regard, FIGS. 8 and 9 illustrate the method for a given data link of a cluster. This method is in connection with one node of a cluster; however, it should be kept in mind that, in practice, the method is applied substantially simultaneously to all nodes in a given cluster.

In other words, a heart beat peer (corresponding to the master's heart beat) is installed on each cluster node, e.g. implemented in its probe module. A heart beat peer is a module which can reply automatically to the heart beat protocol launched by the master node.

Where maximum security is desired, a separate corresponding heart beat peer may also be installed on each data link, for itself. This means that the heart beat protocol as illustrated in FIGS. 8 and 9 may be applied in parallel to each data link used by nodes of the cluster to transmit data throughout the network.

This means that the concept of “node”, for application of the heart beat protocol, may not be the same as the concept of node for the transmission of data throughout the network. A node for the heart beat protocol is any hardware/software entity that has a critical role in the transfer of data. Practically, all items being used should have some role in the transfer of data; so this supposes the definition of some kind of threshold, beyond which such items have a “critical role”. The threshold depends upon the desired degree of reliability.

It is low where high availability is desired.

For a given data link, it is now desired that a failure detection of this data link and any cluster node using this data link should be recognized within delay time S2. This has to be obtained where data transmission uses the Internet protocol.

The basic concept of the heart beat protocol is as follows:
the master node sends a multicast message, containing the current list of nodes using the given data link, to all nodes using the given data link, with a request to answer;
the answers are noted; if no answers, the given data link is considered to be failing data link;
those nodes which meet a given condition of “lack-of-answer” are deemed to be failing nodes. The given condition may be e.g. “Two consecutive lacks of answer”, or more sophisticated conditions depending upon the context.

However, in practice, it has been observed that:
in the multicast request, it is not necessary to request an answer from those nodes who have been active very recently;
instead of sending the full list of currently active nodes, the “active node information” may be sent in the form of changes in that list, subject to possibly resetting the list from time to time;
alternatively, the “active node information” may be broadcasted separately from the multicast request.

Now, with reference to FIG. 8:
at a time tm, m being an integer, the master node (its manager) has:
   a current list LS0_{cu} of active cluster nodes using the given data link,
   optionally, a list LS1 of cluster nodes using the given data link having sent messages within the time interval [tm−S1, tm] in operation 510, i.e. within less than S1 from now.
operation 520, at time tm, starts counting until tm+S2.
at the same time tm (or very shortly thereafter), the master manager launches, i.e. its probe module launches the heart beat protocol (master version).
the master node (more precisely, e.g. its management layer) sends a multicast request message containing the current list LS0_{cu} (or a suitable representation thereof) to all nodes using the given data link and having the heart beat protocol, with a request for response from at least the nodes which are referenced in a list LS2.
in operation 530, the nodes sends a response to the master node for the request message. Only the nodes referenced in list LS2 need to reply to the master node. This heart beat protocol in operation 530 is further developed in FIG. 9.
operation 540 records the node responses, e.g. acknowledge messages, which fall within a delay time of S2 seconds. The nodes having responded are considered operative, while each node having given no reply within the S2 delay time is marked with a “potential failure data”. A chosen criterion may be applied to such “potential failure data” for determining the failing nodes. The criterion may simply be “the node is declared failing as from the first potential failure data encountered for that node”. However, more likely, more sophisticated criteria will be applied: for example, a node is declared to be a failed node if it never answers for X consecutive executions of the heart beat protocol. According to responses from nodes, manager 11 of the master node defines a new list LS0_{new} of active cluster nodes using the given data link. In fact, the list LS0_{cu} is updated, storing failing node identifications to define the new list.

The management layer in relation with the probe module may be defined as a “node failure detection function” for a master node.

The heart beat protocol may start after a delay time P (tm+1=tm+P)

FIG. 9 illustrates the specific function according to the invention used for nodes other than master node and for the master node in the heart beat protocol hereinabove described.

Hereinafter, the term “connection”, similar to the term “link”, can be partially defined as a channel between two determined nodes adapted to issue packets from one node to the other and conversely.
at operation 522, each node receiving the current list LS0_{cu} (or its representation) will compare it to its previous list LS0ₚᵣ. If a node referenced in said current list LS0_{cu} is detected as a failed node, the node manager (CMM), using a probe module, calls a specific function. This specific function is adapted to request a closure of some of the connections between the present node and the node in failure condition. This specific function is also used in case of an unrecoverable connection transmission fault.

As an example, the protocol stack 10 may comprise the known FreeBSD layer, which can be obtained at www.freebsd.org (see Exhibit 2 f- in the code example). The specific function may be the known ioctl( ) method included in the free BSD layer. This function is implemented in the multiple data link interface 101 and corresponds to the cgtp_ioctl( ) function (see the code extract in Exhibit 2 a-). In an embodiment of the invention, in case of a failure of a node, the cqtp_ioctl( ) function provides as entry parameters:
a parameter designating the protocol stack 10;
a control parameter called SICSIFDISCNODE (see Exhibit 2c-);
a parameter designating the IP address of the failed node, that is to say designating the IP address of the multiple data link interface of the failed node.

Then, in presence of the SICSIFDISCNODE control parameter, the cgtp_ioctl( ) function may call the cgtp_tcp_close( ) function (see Exhibit 2 b-). This function provides as entry parameters:
a parameter designating the multiple data link interface 101;
a parameter designating the IP address of the failed node.

The upper layer of the protocol stack 10 may have a table listing the existing connections and specifying the IP addresses of the corresponding nodes. The cgtp_tcp_close( ) function compares each IP address of this table with the IP address of the failed node. Each connection corresponding to the IP address of the failed node is closed. A call to a sodisconnect( ) function realizes this closure.

In an embodiment, the TCP function 106 may comprise the sodisconnect( ) function and the table listing the existing connections.

This method requests the kernel to close all connections of a certain type with the failed node, for example all TCP/IP connections with the failed node. Each TCP/IP connection found in relation with the multiple data link interface of the failed node is disconnected. Thus, in an embodiment, other connections may stay opened, for example the connections found in relation with the link level interfaces by-passing the multiple data link interface. In another embodiment, other types of connection (e.g. Stream Control Transport Protocol, SCTP) may also be closed, if desired. The method proposes to force the pending system calls on each connection with the failed node to return an error code and to return an error indication for future system calls using each of these connections. This is an example; any other method enabling substantially unconditional fast cancellation and/or error response may also be used. The condition in which the errors are returned and the way they are propagated to the applications are known and used e.g. TCP socket API.

The term “to close connections” may designate to put connections in a waiting state. Thus, the connection is advantageously not definitively closed if the node is then detected as active.

Thus, each node of the group of nodes comprises
a first function capable of marking a pending message as in error,
a node failure storage function, and
a first function capable of marking a pending message as in error,
a node failure storage function, and
a second function, responsive to the node failure storage function indicating a given node as failing, for calling said first function to force marking selected messages to that given node into error, the selected messages comprising future and pending messages which satisfy a given condition.

The term “node failure storage function” may designate a function capable of storing lists of nodes, specifying failed nodes.

Forcing existing and/or future messages or packets to a node into error may also be termed forcing the connections to the node into error. If the connections are closed, the sending of packets is forbidden from the sending node to the receiving node for current and future packets.
at operation 524, each node receiving this current list LS0_{cu} (or its representation) updates its own previous list of nodes LS0ₚᵣ. This operation may be done by the management layer of each non master node Ni′. The management layer of a non master node Ni′ may be designated as a “node failure registration function”.

The messages exchanged between the nodes during the heart beat protocol may be user datagrams along the UDP/IP protocol.

The above described process is subject to several alternative embodiments.

The list LS2 is defined such that the master node should, within a given time interval S2, have received responses from all the nodes using the given data link and being operative. Then:
in the option where a list LS1 of recently active nodes is available, the list LS2 may be reduced to those nodes of list LS0_{cu} which do not appear in list LS1, i.e. were not active within less than S1 from time tm (thus, LS2=LS0_{cu}−LS1).
in a simpler version, the list LS2 always comprises all the nodes of the cluster, appearing in list LS0_{cu}, in which case list LS1 may not be used.
the list LS2 may be contained in each request message.

Advantageously, each request message has its own unique id (identifier) and each corresponding acknowledge message has the same unique id. Thus, the master node may easily determine the nodes which do not respond within time interval S2, from comparing the id of the acknowledgment with that of the multicast request.

In the above described process, the list LS0 is sent together with the multicast request. This means that the list LS0 is as obtained after the previous execution of the heartbeat protocol, LS0_{cu}, when P<S2. Alternatively, the list LS0 may also be sent as a separate multicast message, immediately after it is established, i.e. shortly after expiration of the time interval S2, LS0_{cu}=LS0_{new}, when P=S2.

Initially, the list LS0 may be made from an exhaustive list of all nodes using the given data link (“referenced nodes”) which may belong to a cluster (e.g. by construction), or, even, from a list of all nodes using the given data link in the network or a portion of it. It should then rapidly converge to the list of the active nodes using the given data link in the cluster.

Finally, it is recalled that the current state of the nodes may comprise the current state of interfaces and links in the node.

Symmetrically, each data link may use this heart beat protocol illustrated with FIGS. 8 and 9.

If a multi-tasking management layer is used in the master node and/or in other nodes, at least certain operations of the heart beat protocol may be executed in parallel.

The processing of packets, e.g. IP packets, forwarded from sending nodes to the manager 11 will now be described in more detail, on an example.

The source field of the packets is identified by the manager 11 in the master node, which also maintains a list with at least the IP address of sending nodes. The IP address of data link may be also specified in the list. This list is list LS0 of sending nodes.

In case of only realization in the operating system, manager 11 gets list LS1 with a specific parameter permitting to retrieve the description of cluster nodes before each heart beat protocol.

An example of practical application is illustrated in FIG. 10, which shows a single shelf hardware for use in telecommunication applications. This shelf comprises a main sub-cluster and a “vice” master. The main sub-cluster comprises master node NM, nodes N1a and N2a, and payload cards 1a and 2a. These payload cards may be e.g. Input/Output cards, furnishing functionalities to the processor(s), e.g. Asynchronous Transfer Mode (ATM) functionality. In parallel, the “vice” sub-cluster comprises “vice” master node NVM, nodes N1b and N2b, and payload cards 1b and 2b. Each node Ni of cluster K is connected to a first Ethernet network via links L1-i and a 100 Mbps Ethernet switch ES1 capable of joining one node Ni to another node Nj. In an advantageous embodiment, each node Ni of cluster K is also connected to a second Ethernet network via links L2-i and a 100 Mbps Ethernet switch ES2 capable of joining one node Ni to another node Nj in a redundant manner.

Moreover, payload cards 1a, 2a, 1b and 2b are linked to external connections R1, R2, R3 and R4. In the example, a payload switch connects the payload cards to the external connections R2 and R3.

This invention is not limited to the hereinabove described features.

Thus, the management layer may not be implemented in user level. Moreover, the manager or master for the heart beat protocol may not be the same as the manager or master for the practical (e.g. telecom) applications.

Furthermore, the networks may be non-symmetrical, at least partially: one network may be used to communicate with nodes of the cluster, and the other network may be used to communicate outside of the cluster. Another embodiment is to avoid putting a gateway between cluster nodes in addition to the present network, in order to reduce delay in node heart beat protocol, at least for IP communications.

In another embodiment of this invention, packets,

e.g. IP packets, from sending nodes may stay in the operating system.

Exhibit 1
I - Routing table

| Cluster node | Network 31 | Network 31 | Network 32 | Network 32 |
|---|---|---|---|---|
| IP 10 | IP 12 | Ethernet 12 | IP 14 | Ethernet 14 |
| 192.33.15.2 | 192.33.15.3 | 0:0:c0:e3:55:2f | 192.33.15.4 | 8:0:20:89: |
| | | | | 33:c7 |
| 192.33.15.10 | 192.33.15.11 | 8:0:20:20:78:10 | 192.33.15.12 | 0:2:88:11: |
| | | | | 66:e2 |

Exhibit 2

```
a- cgtp_ioctl( ).
    static int
  cgtp_ioctl(struct ifnet* ifp, u_long cmd, caddr_t data)
  {
    struct ifaddr* ifa;
    int error;
    int oldmask;
    struct cgtp_ifreq* cif;
    error = 0;
    ifa = (struct ifaddr*)data;
    oldmask = splimp();
    switch (cmd) {
      case SIOCSIFDISCNODE:
        cif = (struct cgtp_ifreq*) data;
        error = cgtp_tcp_close ((struct if_cgtp*) ifp, &cif->node);
        break;
      /* other auxiliary cases are provided in the complete native code */
      default:
        error = EINVAL;
        break;
    }
    splx(oldmask);
    return(error);
  }
b- cgtp_tcp_close( )
  static int
  cgtp_tcp_close(struct if_cgtp* ifp, struct cgtp_node* node)
  {
    struct inpcb *ip, *ipnxt;
    struct in_addr node_addr;
    struct sockaddr* addr;
    addr = &node->addr;
    if (addr->sa_family != AF_INET) {
      return 0;
    }
    if (addr->sa_len != sizeof(struct sockaddr_in)) {
      return 0;
    }
    node_addr = ((struct sockaddr_in*) addr)->sin_addr;
    for (ip = tcb.lh_first; ip != NULL; ip = ipnxt) {
      ipnxt = ip->inp_list.le_next;
      if(ip->inp_faddr.s_addr == node_addr.s_addr) {
        sodisconnect(ip->inp_socket);
      }
    }
    return 0;
  }
c- SIOCSIFDISCNODE
    #define  SIOCSIFDISCNODE
    _IOW(‘i’, 92, struct cgtp_ifreq)
d-struct cgtp_ifreq { }
  struct cgtp_ifreq {
    struct ifreq ifr;
    struct cgtp_node node;
  };
e- struct cgtp_node{ }
      #define CGTP_MAX_LINKS (2)
  struct cgtp_node
    struct sockaddr addr;
    struct sockaddr rlinks[CGTP_MAX_LINKS];
  };
f- Free BSD
      #include <net/if.h>
```

1. A distributed computer system, comprising a group of nodes, each having:
a network operating system enabling one-to-one messages and one-to-several messages between said nodes,
a first function capable of marking a pending message as in error,
a node failure storage function, and
a second function, responsive to the node failure storage function indicating a given node as failing, for calling said first function to force marking selected messages to that given node into error, the selected messages comprising pending messages which satisfy a given condition.

2. The distributed computer system of claim 1, wherein the second function, responsive to the node failure storage function indicating a given node as failing, is adapted to call said first function to further force marking selected future messages to said given node into error, the selected messages comprising future messages which satisfy a given condition.

3. The distributed computer system of claim 1, wherein the node failure storage function is arranged for storing identifications of failing nodes from successive lack of response of such a node to an acknowledgment-requiring message.

4. The distributed computer system of claim 1, wherein the given condition comprises the fact a message specifies the address of said given node as a destination address.

5. The distributed computer system of claim 1, wherein:
said group of nodes has a master node,
said master node having a node failure detection function, capable of:
repetitively sending an acknowledgment-requiring message from the master node to at least some of the other nodes,
responsive to a given node failure condition, involving possible successive lack of responses from the same node, storing identification of that node as a failing node in the node failure storage function of the master node, and sending a corresponding node status update message to all other nodes in the group, and
each of the non master nodes having a node failure registration function responsive to receipt of such a node status update message for updating a node storage function of the non master node.

6. The distributed computer system of claim 1, wherein the first and second functions are part of the operating system.

7. The distributed computer system of claim 5, wherein each node of the group having a node storage function for storing identifications of each node of the group and, responsive to the node failure storage function, updating identifications of failing nodes.

8. The distributed computer system of claim 1, wherein each node uses a messaging function called Transmission Transport Protocol.

9. The distributed computer system of claim 5, wherein the node failure detection function in master node uses a messaging function called User Datagram Protocol.

10. The distributed computer system of claim 5, wherein the node failure registration function in non master node uses a messaging function called User Datagram Protocol.

11. A method of managing a distributed computer system, comprising a group of nodes, said method comprising the steps of:
detecting at least one failing node in the group of nodes,
issuing identification of that given failing node to all nodes in the group of nodes,
responsive to the step of issuing identification of that given failing node to all nodes in the group of nodes:
storing an identification of that given failing node in at least one of the nodes,
calling a function in at least one of the nodes to force marking selected messages between that given failing node and said node into error, the selected messages comprising pending messages which satisfy a given condition.

12. The method of claim 11, wherein the step of calling a function in at least one of the nodes to force marking selected messages between that given failing node and said node into error, the selected messages comprising pending messages which satisfy a given condition further comprises calling a function in at least one of the nodes to force marking selected messages between that given failing node and said node into error, the selected messages comprising future messages which satisfy a given condition.

13. The method of claim 11, wherein the method further comprises
repeating in time the steps of:
detecting at least one failing node in the group of nodes,
issuing identification of that given failing node to all nodes in the group of nodes,
responsive to the step of issuing identification of that given failing node to all nodes in the group of nodes:
storing an identification of that given failing node in at least one of the nodes,
calling a function in at least one of the nodes to force marking selected messages between that given failing node and said node into error, the selected
messages comprising pending messages which
satisfy a given condition.

14. The method of claim 11, wherein the given condition in the step of calling a function in at least one of the nodes to force marking selected messages between that given failing node and said node into error comprises the fact a message specifies the address of said given node as a destination address.

15. The method of claim 11, wherein the step of detecting at least one failing node in the group of nodes further comprises:
electing one of the nodes as a master node in the group of nodes,
repetitively sending an acknowledgment-requiring message from a master node to all nodes in the group of nodes,
responsive to a given node failure condition, involving possible successive lack of responses from the same node, storing identification of that node as a failing node in the master node.

16. The method of claim 15, wherein of detecting at least one failing node in the group of nodes further comprises storing identification of the given failing node in a master node list.

17. The method of claim 16, wherein the step of detecting at least one failing node in the group of nodes further comprises deleting identification of the given failing node in the master node list.

18. The method of claim 11, wherein the step of issuing identification of that given failing node to all nodes in the group of nodes further comprises sending the master node list to all nodes in the group of nodes.

19. The method of claim 11, wherein the step of storing an identification of that given failing node in at least one of the nodes further comprises updating a node list in all nodes with the identification of the given failing node.

20. The method of claim 11, wherein the step of calling a function in at least one of the nodes to force marking selected messages between that given failing node and said node into error, the selected messages comprising pending messages which satisfy a given condition, further comprises calling the function in a network operating system of at least one node.

21. A software product, comprising the software functions used in a distributed computer system, comprising a group of nodes, each having:
a network operating system enabling one-to-one messages and one-to-several messages between said nodes,
a first function capable of marking a pending message as in error,
a node failure storage function, and
a second function responsive to the node failure storage function indicating a given node as failing, for calling said first function to force marking selected messages to that given node into error, the selected messages comprising pending messages which satisfy a given condition.

22. A software product, comprising the software functions for use in a method of managing a distributed computer system, comprising a group of nodes, said method comprising the steps of:
detecting at least one failing node in the group of nodes,
issuing identification of that given failing node to all nodes in the group of nodes,
responsive to the step of issuing identification of that given failing node to all nodes in the group of nodes:
storing an identification of that given failing node in at least one of the nodes,
calling a function in at least one of the nodes to force marking selected messages between that given failing node and said node into error, the selected messages comprising pending messages which satisfy a given condition.

23. A network operating system, comprising a software product, comprising the software functions used in a distributed computer system, comprising a group of nodes, each having:
a network operating system enabling one-to-one messages and one-to-several messages between said nodes,
a first function capable of marking a pending message as in error,
a node failure storage function, and
a second function, responsive to the node failure storage function indicating a given node as failing, for calling said first function to force marking selected messages to that given node into error, the selected messages comprising pending messages which satisfy a given condition.

24. A network operating system, comprising a software product comprising the software functions for use in a method of managing a distributed computer system, comprising a group of nodes, said method comprising the steps of:
detecting at least one failing node in the group of nodes,
issuing identification of that given failing node to all nodes in the group of nodes,
responsive to the step of issuing identification of that given failing node to all nodes in the group of nodes:
storing an identification of that given failing node in at least one of the nodes,
calling a function in at least one of the nodes to force marking selected messages between that given failing node and said node into error, the selected messages comprising pending messages which satisfy a given condition.
